(19) United States
(12) Patent Application Publication
(10) Pub. No.: US 2015/0011259 A1
(43) Pub. Date: Jan. 8, 2015

(54) REMOTE DISPLAY FOR COMMUNICATIONS DEVICE

(71) Applicant: NVIDIA Corporation, Santa Clara, CA (US)

(72) Inventor: Repesh Chirde, District Yavatmal (IN)

(73) Assignee: NVIDIA Corporation

(21) Appl. No.: 13/935,661

(22) Filed: Jul. 5, 2013

(51) Int. Cl. H04M 1/725; H04R 1/10

(52) U.S. Cl. CPC H04M 1/72519; H04R 1/1041; H04R 1/1033
USPC 455/557; 381/74

(57) ABSTRACT

Provided in one aspect are headphones. The headphones, in accordance with this disclosure, include one or more electro-acoustic transducers operable to convert electrical signals into sounds. The headphones, in this aspect, further include a display in communication with the one or more electro-acoustic transducers. The display, in this aspect, is operable to receive one or more images from an associated electronic device.

### TECHNICAL FIELD

This application is directed, in general, to a remote display and, more specifically, to a remote display for a communications device.

### BACKGROUND

Electronic devices, particularly communication devices such as smartphones, tablets, MP3 players, etc., have made vast strides in performance over the last decade or so. Not only have they made vast strides in performance, their form factor and size has significantly decreased. Unfortunately, even though their performance has significantly improved, and their form factor and size has greatly decreased, such electronic devices are still difficult to use when they are stored in a user's pocket, purse, backpack, etc.

Accordingly, what is needed in the art is an electronic device, or device for use therewith, that navigates the foregoing problem.

### SUMMARY

One aspect provides headphones. The headphones, in accordance with this disclosure, include one or more electro-acoustic transducers operable to convert electrical signals into sounds. The headphones, in this aspect, further include a display in communication with the one or more electro-acoustic transducers. The display, in this aspect, is operable to receive one or more images from an associated electronic device.

Provides in another aspect is a remote display for a communications device. The remote display, in accordance with this disclosure, includes a chassis and a display positioned within the chassis. The display, in this embodiment, is operable to provide an interface to control one or more functional features of a connected communications device having a communications device display.

### BRIEF DESCRIPTION

Reference is now made to the following descriptions taken in conjunction with the accompanying drawings, in which:

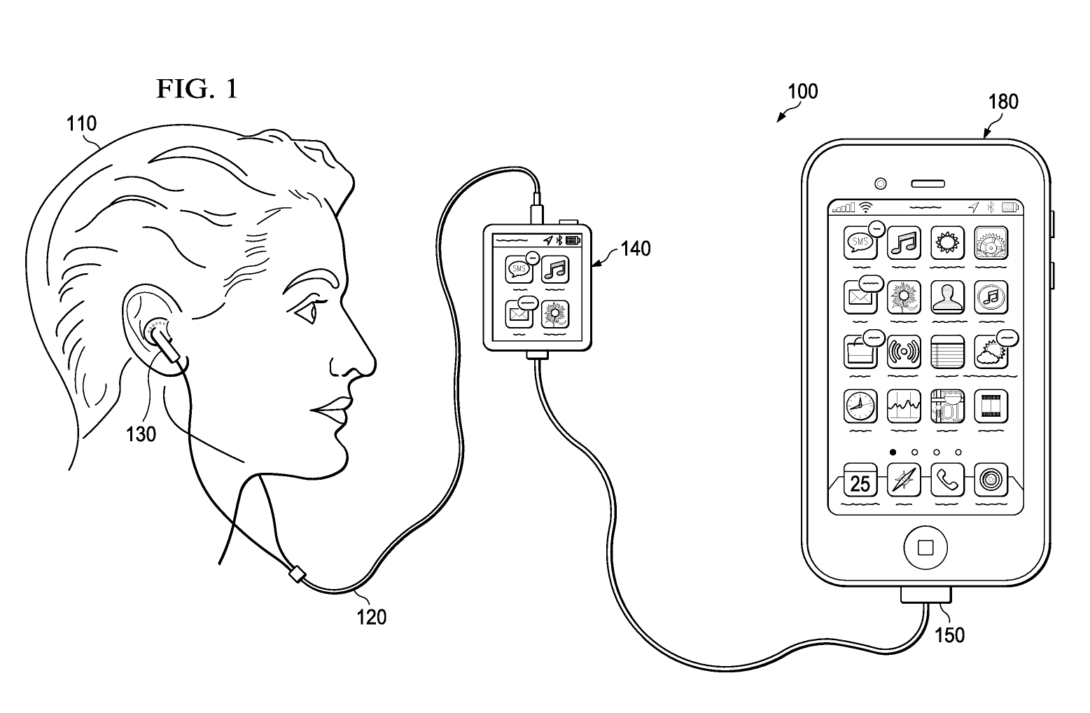

FIG. 1 illustrates a scenario wherein a user is using headphones coupled to an electronic device via a hard-wired connection;

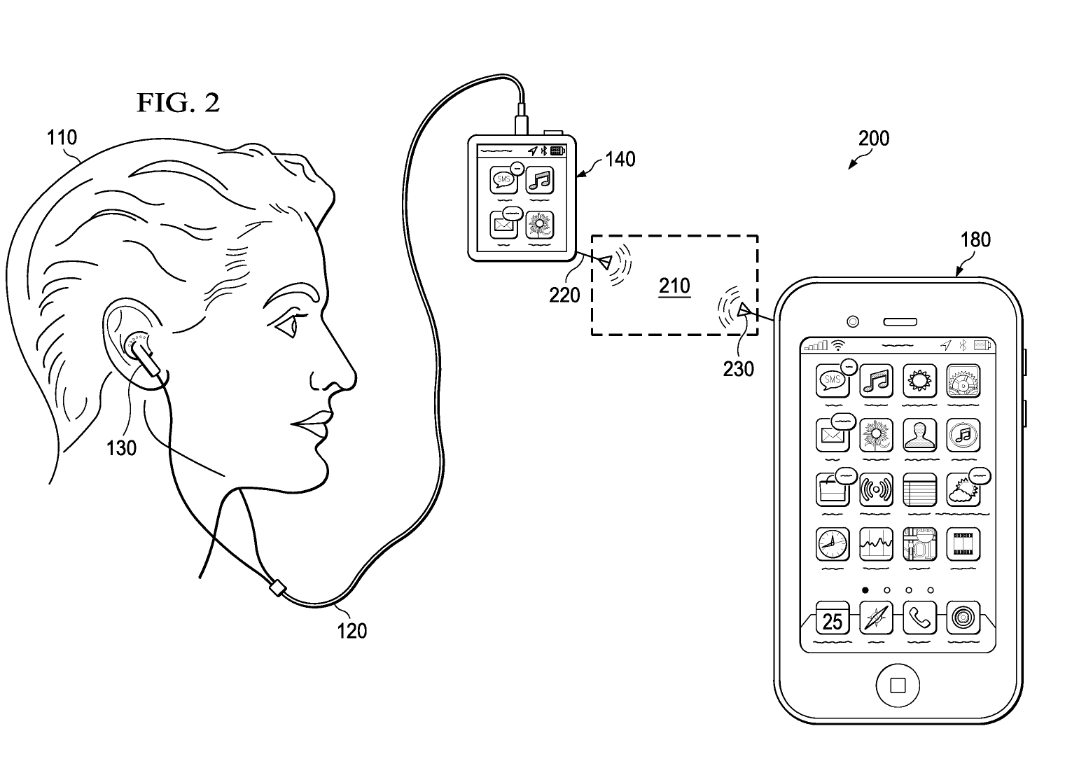

FIG. 2 illustrates a scenario similar to the scenario illustrated in FIG. 1, but with a wireless connection between the display and the electronic device;

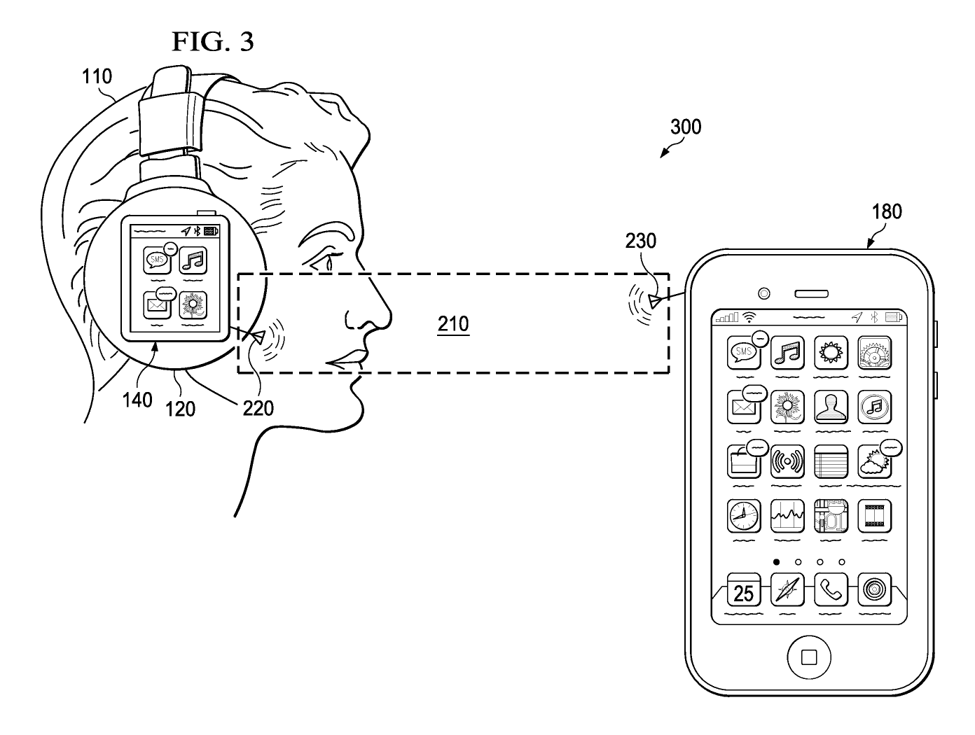

FIG. 3 illustrates a scenario, similar to the scenario illustrated in FIG. 2;

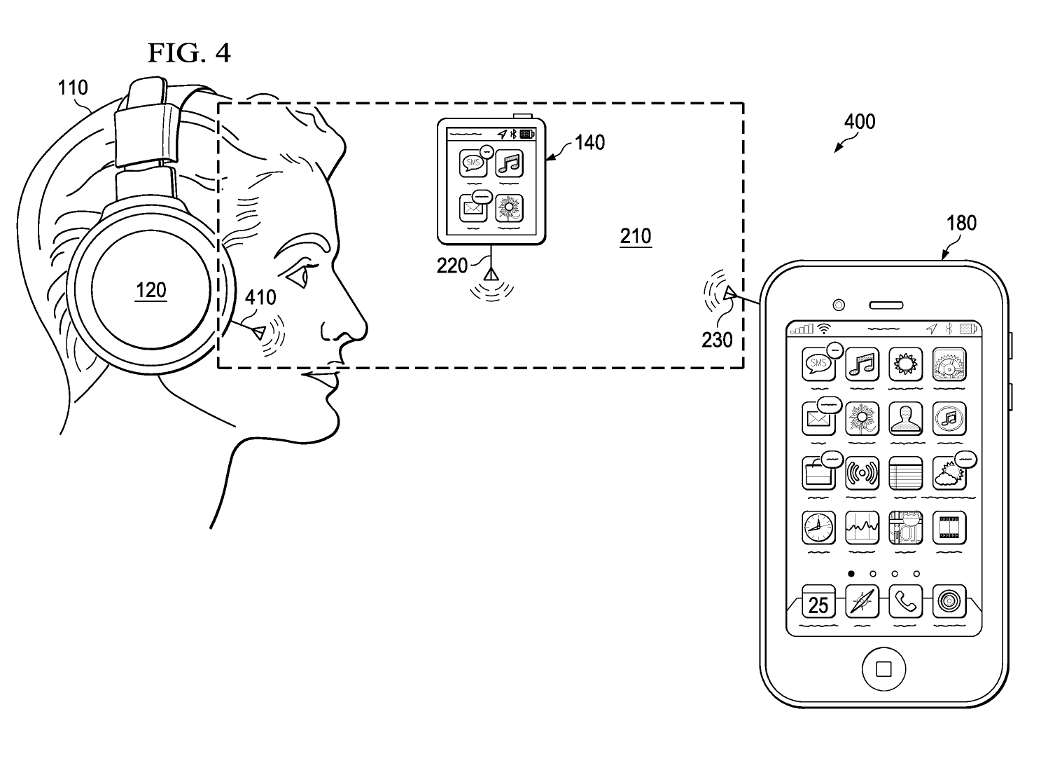

FIG. 4 illustrates a scenario similar to the scenario illustrated in FIG. 3, but with a wireless connection between the electro-acoustic transducers, the display and the electronic device;

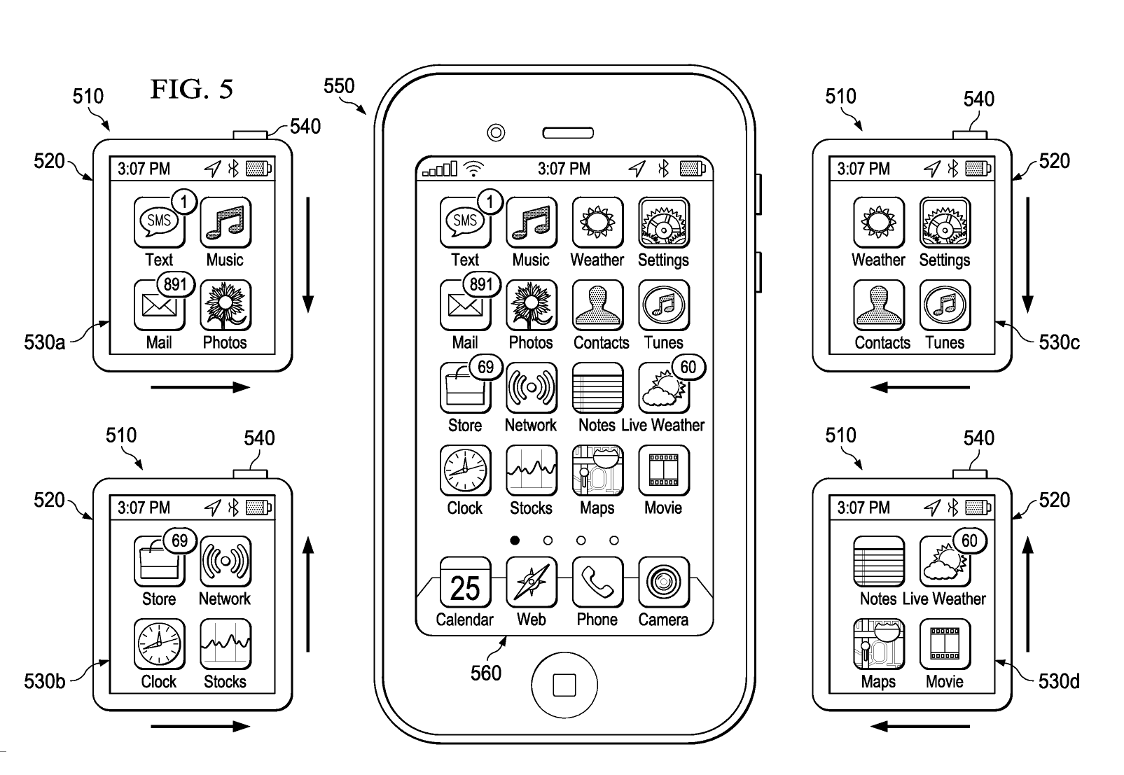

FIG. 5 illustrates a remote display manufactured in accordance with the present disclosure that is in communication with a mobile communications device; and

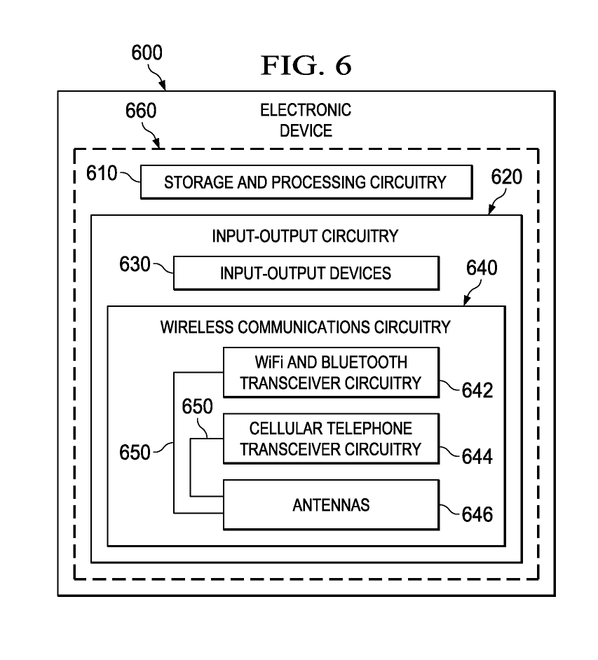

FIG. 6 illustrates a schematic diagram of electronic device, as might be used with a display manufactured and operated in accordance with this disclosure.

### DETAILED DESCRIPTION

The present disclosure is based, at least in part, on the acknowledgement that users of today's electronic devices often tend to be on the go. The present disclosure is further based, at least in part, on the acknowledgement that users of today's electronic devices often also tend to use headphones with their electronic devices. Moreover, the present disclosure has acknowledged that users that tend to use headphones with their electronic device, typically store their electronic device out of eyesight (e.g., within a pocket, purse, backpack, etc.). When the electronic device is out of site, the users cannot easily see who is calling, emailing or texting, check the time, or any other small task that one might need to accomplish.

With the foregoing acknowledgments in mind, the present disclosure has recognized that many of the aforementioned problems can be mitigated by including a display (e.g., small display as it relates to the size of the main electronic device) as part of the headphones. For instance, the display might be in communication with one or more electro-acoustic transducers operable to convert electrical signals into sounds, but also be operable to receive one or more images from an associated communications device (e.g., including an associated communications device having a communications device display). In this instance, the display could be used to show images, such as caller information, email information or text information, among other information, as that information becomes available to the associated electronic device—even though the electronic device may still be out of eyesight.

FIG. 1 illustrates a scenario 100, wherein a user 110 is using headphones 120 coupled to an electronic device 180. The headphones 120, in accordance with the present disclosure, include one or more electro-acoustic transducers 130 operable to convert electrical signals into sounds. It should be noted that while the embodiment illustrated in FIG. 1 implies (if not shows) that two electro-acoustic transducers 130 are being employed by the user 110, other embodiments exist wherein only a single electro-acoustic transducer 130, or more than two electro-acoustic transducers 130, may be used. Accordingly, the term “headphones”, as used herein, is not limited to only two electro-acoustic transducers 130.

The headphones 120 illustrated in FIG. 1 are in-ear headphones. All types of in-ear headphones are within the scope of the present disclosure, including those that rest within the ear lobe, and those that extend within the ear canal. While not shown in FIG. 1, additional embodiments exist wherein the headphones 120 are over-the-ear headphones.

The headphones 120, in accordance with the present disclosure, include a display 140 in communication with the one or more electro-acoustic transducers 130. The term communication, as it relates to the cooperation of the display 140 and the one or more electro-acoustic transducers 130, includes communications that originate from the electronic device 180 and are otherwise modified or manipulated by the display 140 on their way to the one or more electro-optic transducers 130. The term communication, as it relates to the cooperation of the display 140 and the one or more electro-acoustic transducers 130, additionally includes communications that originate at the display 140 and are then transmitted to the one or more electro-optic transducers 130. The term communication, as it relates to the cooperation of the display 140 and the one or more electro-acoustic transducers 130, even yet includes communications that are generated by the electronic device 180 and pass through the display 140, without any modification or manipulation by the display 140, on their way to the one or more electro-optic transducers 130.

The display 140, in accordance with the disclosure, is operable to receive one or more images from the associated electronic device 180. The type of image that the display 140 is operable to receive from the associated electronic device 180 may vary greatly. In one embodiment, the display 140 receives caller information as it is transmitted to the electronic device 180. For instance, if the user 110 gets a telephone call while the electronic device 180 is in his/her pocket, caller ID information for the incoming call might be shown on the display 140. Accordingly, the user 110 would have an opportunity to take the call if he/she desires. In accordance with one embodiment of the disclosure, the display 140 might provide an interface to initiate the telephone call (e.g., answer the telephone call). In accordance with another embodiment, of the disclosure, the user 110 might have to retrieve the electronic device 180 to answer the call. The display 140 could equally be used to recognize, and/or listen to, voicemails that the electronic device 180 receives.

Similarly, the one or more images might be email information or text information as such information gets transmitted to the electronic device 180. Accordingly, the user 110 would quickly have the knowledge of an incoming email or text, and thus have the opportunity to answer that email or text if he/she so desired. Again, the display 140 might provide an interface to initiate (e.g., answer) the email or text, or alternatively, the user 110 might be required to retrieve the electronic device 180 to initiate the email or text.

The display 140, in accordance with the present disclosure, may also be operable to receive from the electronic device 180 pictures that are accessible from the electronic device 180. For example, a user 110 could access photos on the electronic device 180 and show them on the display 140, even though the electronic device 180 is out of sight. In this embodiment, as opposed to the pictures being stored on the display 140, they are stored on the electronic device 180 and temporarily shown on the display 140.

The display 140, in accordance with the disclosure, is configurable to show certain features of the electronic device 180. For example, the display 140 might show the features for email, text, music and the phone of the electronic device. In the case of many electronic devices, these features would be shown in the form of icons, wherein the icons shown on the display 140 mimic the related icons shown on the electronic device 180. In certain embodiments, the particular electronic device 180 features shown on the display 140 are fixed standard features, such as email, text, music and phone. In another embodiment, however, the display 140 is user configurable (e.g., customizable) to display certain less common but desired features of the electronic device 180, such as maps, weather, photos, a particular game, etc. Not only does the display 140 show certain features of the electronic device 180, in certain embodiments the display 140 provides an interface to access such features of the electronic device 180.

In accordance with one embodiment of the disclosure, the display 140 is operable to slave off the storage and processing circuitry of the electronic device 180. In this embodiment, the display 140 would likely still require display circuitry, and might require a small amount of related storage and processing circuitry, but for the most part the display 140 would be leveraging off of the more powerful storage and processing circuitry of the electronic device 180. Because the display 140 is operable to leverage off of the storage and processing circuitry of the electronic device 180, the display could be smaller in size and less expensive to manufacture. Other embodiments exist, however, wherein the display 140 relies significantly upon its own storage circuitry, processing circuitry, or both storage and processing circuitry.

The display 140, in the embodiment shown, is configured to receive the one or more images from the electronic device 180 over a hard-wired connection 150. The hard-wired connection 150 may be any currently known, or hereafter discovered, hard-wired connection that is consistent with the features/functionality of the present disclosure. In one embodiment, the hard-wired connection 150 is a USB connector. For example, the hard-wired connection 150 could be a standard USB connector, a micro USB connector, or a USB mini connector, among other possible USB connectors. In another embodiment, the hard-wired connection 150 is a Firewire connector or Thunderbolt connector. In those embodiments wherein the electronic device is an Apple product (e.g., IPod, IPhone, IPad, etc.), the hard-wired connection 150 might be an Apple 30-pin connector, or in later generations, an Apple lightning connector.

Unique to the present disclosure, the presence of a connection between the display 140 and the electronic device 180 may optionally be used to trigger the main display of the electronic device 180 to turn off. For example, if the electronic device 180 senses a connection with the display 140, it may turn its main display off to conserve power. This may be the case even when various different types of information are being transmitted to the electronic device 180. Ultimately, a call, email or text might never be displayed on the main display of the electronic device 180 while the display 140 is connected thereto, and might only show up when the connection is broken. Other scenarios may nonetheless exist wherein the main display of the electronic device 180 remains on while a connection exists between the electronic device 180 and the display 140.

Turning briefly to FIG. 2, illustrated is a scenario 200, similar to the scenario 100 illustrated in FIG. 1. In the embodiment of FIG. 2, the display 140 is configured to receive the one or more images from the electronic device 180 over a wireless connection 210. Accordingly, the display 140 illustrated in FIG. 2 would additionally include an antenna 220 for communication with an antenna 230 of the electronic device 180.

Those skilled in the art understand the various different types of wireless connections 210 (e.g., communication protocols) that might be used to wirelessly connect the display 140 and the electronic device 180. For example, in one embodiment the display 140 and the electronic device 180 communicate using a Bluetooth® wireless connection. In another embodiment, however, the display 140 and electronic device 180 communicate using a WiFi® wireless connection. Other wireless connections 210, whether currently know or hereafter discovered, are within the scope of the present disclosure.

The display 140, in the embodiment of FIG. 2, is physically connected to the one or more electro-optic transducers 130. In the embodiment of FIG. 2, the physical connection is an appropriate length headphone wire. In this embodiment, the length of the headphone wire may be properly chosen such that the user 110 can view the display 140 while the one or more electro-optic transducers 130 are in use.

Turning briefly to FIG. 3, illustrated is a scenario 300, similar to the scenario 200 illustrated in FIG. 2. In the embodiment of FIG. 3, the display 140 is attached (e.g., removably or fixedly attached) to the headphones 120. In the embodiment of FIG. 3, the headphones 120 are over-the-ear headphones, and the display 140 is attached to the over-the-ear portion of the headphones 120. The display 140, similar to FIG. 2, would receive the one or more images from the electronic device 180 over the wireless connection 210, using the antennas 220, 230.

Turning briefly to FIG. 4, illustrated is a scenario 400, similar to the scenario 300 illustrated in FIG. 3. In the embodiment of FIG. 4, display 140 is wirelessly connected to both the headphones 120 and the electronic device 180. Accordingly, the display 140 would use the antenna 220 to communicate with the antenna 230 of the electronic device 180, and vice versa. Likewise, the display 140 would use the antenna 220, or another antenna, to communicate with an antenna 410 of the headphones 120, or vice versa. Ultimately, at least in this embodiment, the electronic device 180 is communicating through the display 140 with the headphones 120.

Returning to FIG. 1, the display 140 may have a variety of different features. In one embodiment, the display 140 has a power button. In this embodiment, the headphones 120 would function like a normal pair of headphones when the display 140 is powered off. Similarly, the display 140 might have a volume key to increase the volume coming from the one or more electro-acoustic transducers 130. Additionally, the display 140 might have an integrated speaker, such that the display could be used to listen to music and/or conference calls.

Turning to FIG. 5, illustrated is a remote display 510 manufactured in accordance with the present disclosure that is in communication with a mobile communications device 550. The remote display 510, in the embodiment shown, includes a chassis 520 and a display 530 positioned therein. The display 530, in the embodiment shown, is a touch screen display. Nevertheless, other display 530 types are within the purview of the present disclosure.

The phrase “mobile communications device”, as used herein, is intended to refer to an electronic device that is mobile in nature and is wirelessly networked to receive remote data (e.g., cellular networked, WiFi networked, Bluetooth networked, etc.). For the purpose of the present disclosure, smartphones, tablet devices, and MP3 players, game players, among others, are considered mobile communications devices. In contrast, desktop computers, servers and other large non-mobile electronic devices are not considered mobile communications devices.

In the illustrated embodiment, the mobile communications device 550 is an Apple IPhone, wherein the features of the mobile communications device 550 may be accessed via icons 570 shown on a mobile communications device display 560. Nevertheless, other electronic devices, including other mobile communications devices, are within the scope of the disclosure.

In the embodiment of FIG. 5, the display 530 mirrors at least a portion of the mobile communications device display 560. For example, display 530a illustrates what might be shown thereon as a user swipes one of his/her digits to the right and down across the display 530. Display 530b illustrates what might be shown thereon as a user swipes one of his/her digits to the right and up across the display 530. Display 530c illustrates what might be shown thereon as a user swipes one of his/her digits to the left and down across the display 530. Display 530d illustrates what might be shown thereon as a user swipes one of his/her digits to the left and up across the display 530. Accordingly, in at least the embodiment of FIG. 5, a quick swipe of a user's digit changes what is shown on the display 510.

Other embodiments exist, however, where the display 530 is not a touch screen display. In these embodiments, buttons positioned along the chassis 520 surrounding the display 530 may be used to mirror different portions of the mobile communications device display 560.

In yet another embodiment, the display 530 mirrors customized portions of the mobile communications device display 560. For example, the display 530 could be customized to mirror the music, weather, photos and contacts portion of the mobile communications device display 560.

The display 530, in the embodiment of FIG. 5, is operable to provide an interface to control one or more functional features of the connected mobile communications device 550. For example, the display 530 may be operable to provide an interface to control telephone call, email or text features of the connected mobile communications device 550. Additionally, the display 530 may be operable to provide an interface to control calendar, internet, camera map, music, weather, etc. features of the connected mobile communications device 550. Ultimately, at least in one embodiment, any feature of the mobile communications device 550 should be able to be controlled (e.g., via an interface) from the display 530.

In the embodiment of FIG. 5, the remote display 510 additionally includes a connector 540. The connector 540, in this embodiment, provides an output to communicate with headphones (e.g., one or more electro-acoustic transducers that are operable to convert electrical signals into sounds). While the connector 540 is illustrated as being on an external surface of the remote display 510, other embodiments exist wherein the connector 540 is located within the confines of the chassis 520.

FIG. 6 illustrates a schematic diagram of electronic device 600, as might be used with a display manufactured and operated in accordance with this disclosure. The aforementioned display, in accordance with the disclosure, would be operable to provide an interface to control one or more functional features of the electronic device 600.

Electronic device 600 may be a portable device such as a mobile telephone, a mobile telephone with media player capabilities, a handheld computer, a remote control, a game player, a global positioning system (GPS) device, a laptop computer, a tablet computer, an ultraportable computer, a combination of such devices, or any other suitable portable electronic device. Electronic device 600 may additionally be a desktop computer, television, or projector system.

As shown in FIG. 6, electronic device 600 may include storage and processing circuitry 610. Storage and processing circuitry 610 may include one or more different types of storage such as hard disk drive storage, nonvolatile memory (e.g., flash memory or other electrically-programmable-read-only memory), volatile memory (e.g., static or dynamic random-access-memory), etc. The processing circuitry may be used to control the operation of device 600. The processing circuitry may be based on a processor such as a microprocessor and other suitable integrated circuits. With one suitable arrangement, the storage and processing circuitry 610 may be used to run software on device 600. The storage and processing circuitry 610 may, in another suitable arrangement, be used to run internet browsing applications, voice-over-internet-protocol (VOIP) telephone call applications, email applications, media playback applications, operating system functions, etc. Storage and processing circuitry 610 may be used in implementing suitable communications protocols.

Communications protocols that may be implemented using storage and processing circuitry 610 include, without limitation, internet protocols, wireless local area network protocols (e.g., IEEE 802.11 protocols—sometimes referred to as WiFi®), protocols for other short-range wireless communications links such as the Bluetooth® protocol, protocols for handling 3 G communications services (e.g., using wide band code division multiple access techniques), 2G cellular telephone communications protocols, etc. The storage and processing circuitry 610 may implement protocols to communicate using cellular telephone bands at 850 MHz, 900 MHz, 1800 MHz, and 1900 MHz (e.g., the main Global System for Mobile Communications or GSM cellular telephone bands) and may implement protocols for handling 3G and 4G communications services.

Input-output device circuitry 620 may be used to allow data to be supplied to device 600 and to allow data to be provided from device 600 to external devices. Input-output devices 630 such as touch screens and other user input interfaces are examples of input-output circuitry 620. Input-output devices 630 may also include user input-output devices such as buttons, joysticks, click wheels, scrolling wheels, touch pads, key pads, keyboards, microphones, cameras, etc. A user can control the operation of device 600 by supplying commands through such user input devices. As discussed above, the user can control the operation of the device 600 using a display associated with headphones (see FIGS. 1-5 above). Display and audio devices may be included in devices 630 such as liquid-crystal display (LCD) screens, light-emitting diodes (LEDs), organic light-emitting diodes (OLEDs), and other components that present visual information and status data. If desired, input-output devices 630 may contain audio-video interface equipment such as jacks and other connectors for external headphones and monitors.

Wireless communications circuitry 640 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications). Wireless communications circuitry 640 may include radio-frequency transceiver circuits for handling multiple radio-frequency communications bands. For example, circuitry 640 may include transceiver circuitry 642 that handles 2.4 GHz and 5 GHz bands for WiFi® (IEEE 802.11) communications and the 2.4 GHz Bluetooth® communications band. Circuitry 640 may also include cellular telephone transceiver circuitry 644 for handling wireless communications in cellular telephone bands such as the GSM bands at 850 MHz, 900 MHz, 1800 MHz, and 1900 MHz, as well as the UMTS and LTE bands (as examples). Wireless communications circuitry 640 can include circuitry for other short-range and long-range wireless links if desired. For example, wireless communications circuitry 640 may include global positioning system (GPS) receiver equipment, wireless circuitry for receiving radio and television signals, paging circuits, etc. In WiFi® and Bluetooth® links and other short-range wireless links, wireless signals are typically used to convey data over tens or hundreds of feet. In cellular telephone links and other long-range links, wireless signals are typically used to convey data over thousands of feet or miles.

Wireless communications circuitry 640 may include one or more antennas 646. Device 600 may be provided with any suitable number of antennas. There may be, for example, one antenna, two antennas, three antennas, or more than three antennas, in device 600. In accordance with that discussed above, the antennas may handle communications over multiple communications bands. If desired, a dual band antenna may be used to cover two bands (e.g., 2.4 GHz and 5 GHz). Different types of antennas may be used for different bands and combinations of bands. For example, it may be desirable to form an antenna for forming a local wireless link antenna, an antenna for handling cellular telephone communications bands, and a single band antenna for handling Bluetooth® communications (as examples).

Paths 650, such as transmission line paths, may be used to convey radio-frequency signals between transceivers 642 and 644, and antenna 646. Radio-frequency transceivers such as radio-frequency transceivers 642 and 644 may be implemented using one or more integrated circuits and associated components (e.g., power amplifiers, switching circuits, matching network components such as discrete inductors, capacitors, and resistors, and integrated circuit filter networks, etc.). These devices may be mounted on any suitable mounting structures. With one suitable arrangement, transceiver integrated circuits may be mounted on a printed circuit board. Paths 650 may be used to interconnect the transceiver integrated circuits and other components on the printed circuit board with antenna structures in device 600. Paths 650 may include any suitable conductive pathways over which radio-frequency signals may be conveyed including transmission line path structures such as coaxial cables, microstrip transmission lines, etc.

The device 600 of FIG. 4 further includes a chassis 660. The chassis 660 may be used for mounting/supporting electronic components such as a battery, printed circuit boards containing integrated circuits and other electrical devices, etc. For example, in one embodiment, the chassis 660 positions and supports the storage and processing circuitry 610, and the input-output circuitry 620, including the input-output devices 630 and the wireless communications circuitry 640 (e.g., including the WIFI and Bluetooth transceiver circuitry 642, the cellular telephone circuitry 644, and the antennas 646).

The chassis 660 may be made of various different materials, including metals such as aluminum. The chassis 660 may be machined or cast out of a single piece of material. Other methods, however, may additionally be used to form the chassis 660.

Those skilled in the art to which this application relates will appreciate that other and further additions, deletions, substitutions and modifications may be made to the described embodiments.

What is claimed is:

1. Headphones, comprising:
one or more electro-acoustic transducers operable to convert electrical signals into sounds; and
a display in communication with the one or more electro-acoustic transducers, the display operable to receive one or more images from an associated electronic device.

2. The headphones of claim 1, wherein the display is configured to receive the one or more images from the electronic device over a hard-wired connection.

3. The headphones of claim 1, wherein the hard-wired connection is selected from the group consisting of:
a standard USB connector;
a micro USB connector;
a USB mini connector;
a firewire connector; and
a thunderbolt connector;

4. The headphones of claim 1, wherein the hard-wired connection is an Apple 30-pin connector or an Apple lightning connector.

5. The headphones of claim 1, wherein the display is configured to receive the one or more images from the electronic device over a wireless connection.

6. The headphones of claim 1, wherein the wireless connection is a Bluetooth® wireless connection.

7. The headphones of claim 1, wherein the one or more images are caller, email or text information as such information gets transmitted to the electronic device.

8. The headphones of claim 1, wherein the one or more images are pictures accessible on the electronic device.

9. The headphones of claim 1, wherein the display provides an interface to initiate telephone calls, emails or texts from the electronic device.

10. The headphones of claim 1, wherein the display is operable to slave off of storage and processing circuitry of the electronic device.

11. The headphones of claim 1, wherein the display contains storage and processing circuitry.

12. The headphones of claim 1, wherein the display is user configurable to show certain features of the electronic device.

13. The headphones of claim 12, wherein the display is user configurable to access certain features of the electronic device.

14. The headphones of claim 1, wherein the display is operable to mirror at least a portion of a main display of the electronic device.

15. The headphones of claim 1, wherein the display is operable to cause a main display of the electronic device to turn off when the display is connected to the electronic device.

16. The headphones of claim 1, wherein the display is a touch screen display.

17. The headphones of claim 1, wherein the display is operable to receive one or more images from an electronic telecommunications device selected from the group consisting of:
a smartphone;
a tablet device; and
an MP3 player.

18. A remote display for a communications device, comprising:
a chassis; and
a display positioned within the chassis, wherein the display is operable to provide an interface to control one or more functional features of a connected mobile communications device having a mobile communications device display.

19. The remote display of claim 18, wherein the display is operable to provide an interface to control telephone call, email or text features of the connected mobile communications device.

20. The remote display of claim 18, wherein the remote display includes a connector for communicating with one or more electro-acoustic transducers that are operable to convert electrical signals into sounds.
